(19) United States
(12) Patent Application Publication
(10) Pub. No.: US 2020/0364640 A1
(43) Pub. Date: Nov. 19, 2020

(54) Optimizing Reserve Crew Patterns

(71) Applicant: Federal Express Corporation, Memphis, TN (US)

(72) Inventors: Ying Zhang, Collierville, TN (US); Richard Lewis, Memphis, TN (US); Suresh Rangan, Frisco, TX (US); Mingzhou Jin, Memphis, TN (US)

(21) Appl. No.: 16/875,527

(22) Filed: May 15, 2020

Related U.S. Application Data
(60) Provisional application No. 62/848,374, filed on May 15, 2019.

(51) Int. Cl. G06Q 10/06; G06Q 10/10; G06Q 10/04; G06F 17/16; G06N 7/00

(52) U.S. Cl. CPC G06Q 10/06312; G06Q 10/1097; G06N 7/005; G06Q 10/04; G06F 17/16; G06Q 10/06315

(57) ABSTRACT

Methods, systems, and apparatus, including computer programs encoded on a computer storage medium, for operations of obtaining input data that includes forecasting data and reserve duty pattern parameters. The operations include iteratively generating additional coverage rate columns for a reserve-demand coverage rate (RDCR) matrix until a stop criterion is satisfied, where each iteration includes: determining a shadow value indicating a marginal value of an incremental change in reserve-demand coverage of the airline trips by solving a set cover problem based on the set of coverage rate columns within the RDCR matrix and using linear problem constraints, the set of coverage rate columns selected for the iteration; generating a new reserve duty pattern, the new reserve duty pattern including an improvement value; and determining whether the improvement value of the new reserve duty pattern satisfies the stop criterion. When the improvement value of the new reserve duty pattern does not satisfies the stop criterion the operations include: generating a new coverage rate column based on the new reserve duty pattern, and appending the new coverage rate column to the RDCR matrix as an additional coverage rate column. If the improvement value of the new reserve duty pattern does satisfy the stop criterion, the operations include ceasing the iteratively generating additional coverage rate columns, and generating, based on the RDCR matrix, a final set of reserve duty patterns.

### CROSS-REFERENCE TO RELATED APPLICATION

This application claims the benefit of the filing date of U.S. Provisional Application No. 62/848,374, filed on May 15, 2019. The contents of U.S. Application No. 62/848,374 are incorporated herein by reference in their entirety.

### BACKGROUND

This disclosure relates generally to set coverage optimization. Set coverage problems can be used to model problems that exist in various disciplines and industries such as computer science, operations research, and logistics. Processes to improve the computational efficiency and accuracy of such modeling are desirable.

### SUMMARY

This specification relates to performing set cover optimization on complex logistical scheduling operations. Implementations are described herein in reference to the example context of airline reserve crew pattern optimization. In general, innovative aspects of the subject matter described in this specification can be embodied in methods that include the operations of obtaining input data that includes forecasting data and reserve duty pattern parameters. The operations include iteratively generating additional coverage rate columns for a reserve-demand coverage rate (RDCR) matrix until a stop criterion is satisfied, where each iteration includes: determining a shadow value indicating a marginal value of an incremental change in reserve-demand coverage of the airline trips by solving a set cover problem based on the set of coverage rate columns within the RDCR matrix and using linear problem constraints, the set of coverage rate columns selected for the iteration; generating a new reserve duty pattern, the new reserve duty pattern including an improvement value; and determining whether the improvement value of the new reserve duty pattern satisfies the stop criterion. When the improvement value of the new reserve duty pattern does not satisfies the stop criterion the operations include: generating a new coverage rate column based on the new reserve duty pattern, and appending the new coverage rate column to the RDCR matrix as an additional coverage rate column. If the improvement value of the new reserve duty pattern does satisfy the stop criterion, the operations include ceasing the iteratively generating additional coverage rate columns, and generating, based on the RDCR matrix, a final set of reserve duty patterns. Other implementations of this aspect include corresponding systems, apparatus, and computer programs, configured to perform the actions of the methods, encoded on computer storage devices.

In some implementations, generating a new reserve duty pattern includes: determining, based on the input data, a plurality of possible reserve duty patterns to cover the plurality of airline trips; determining an improvement value for each of the possible reserve duty patterns, where each improvement value is determined based on the shadow value and a trial coverage rate associated with each possible reserve duty pattern; and selecting a particular reserve duty pattern from among the possible reserve duty patterns based on the particular reserve duty pattern having a respective improvement value that is a highest among all the improvement values of the possible reserve duty patterns.

In another general aspect, innovative aspects of the subject matter described in this specification can be embodied in methods that include the operations of obtaining input data that includes forecasting data and reserve duty pattern parameters. The operations include iteratively generating additional coverage rate columns for a reserve-demand coverage rate (RDCR) matrix until a stop criterion is satisfied, each iteration including: determining, for a set of coverage rate columns within the RDCR matrix, a shadow value indicating a marginal value of an incremental change in reserve-demand coverage of the airline trips, the set of coverage rate columns selected for the iteration; determining, based on the input data, a plurality of possible reserve duty patterns to cover the plurality of airline trips; determining an improvement value for each of the possible reserve duty patterns, where each improvement value is determined based on the shadow value and a trial coverage rate associated with each possible reserve duty pattern; identifying a particular reserve duty pattern from among the possible reserve duty patterns with a respective improvement value that is a highest among all the improvement values of the possible reserve duty patterns; determining whether the respective improvement value satisfies the stop criterion. When the improvement value of the particular reserve duty pattern does not satisfies the stop criterion the operations include: generating a new coverage rate column from the trial coverage rate associated with the particular reserve duty pattern, and appending the new coverage rate column to the RDCR matrix as an additional coverage rate column. When the improvement value of the particular reserve duty pattern does satisfy the stop criterion, the operations include ceasing the iteratively generating additional coverage rate columns, and generating, based on the RDCR matrix, a final set of reserve duty patterns.

These and other implementations can each optionally include one or more of the following features.

In some implementations, the additional coverage rate columns for the RDCR matrix are generated using linear problem constraints.

In some implementations, the final set of reserve duty patterns are generated using integer problem constraints.

In some implementations, the additional coverage rate columns for the RDCR matrix are generated as using linear problem constraints, and wherein the final set of reserve duty patterns are generated using integer problem constraints.

In some implementations, the forecasting data associates a plurality of airline trips with an expected reserve-demand value that indicates a probability that each airline trip will require coverage by a reserve crew. In some implementations, the forecasting data includes at least some expected reserve-demand values associated with multi-day airline trips. In some implementations, the forecasting data includes expected reserve-demand value that are not rounded.

In some implementations, the reserve duty pattern parameters include a reserve pattern length and a minimum number of on duty days per reserve block.

In some implementations, determining the shadow value includes solving a set cover problem based on the set of coverage rate columns within the RDCR matrix and using linear problem constraints. In some implementations, generating the final set of reserve duty patterns includes solving the set cover problem based on a final set of columns of the RDCR matrix and using integer problem constraints.

In some implementations, the operations include generating a revised set of reserve duty patterns by solving a set cover problem based on the RDCR matrix and hybrid forecasting data, wherein the hybrid forecasting data associates a first plurality of airline trips with an actual reserve demand data and a second plurality of airline trips an expected reserve-demand value that indicates a probability that each airline trip will require coverage by a reserve crew.

In some implementations, the reserve duty pattern parameters include a limited number of special reserve duty patterns.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example system for executing implementations of the present disclosure.

FIG. 2 depicts a flowchart of an example reserve crew optimization process that can be executed in accordance with implementations of the present disclosure.

FIG. 3A depicts an example of a simplified coverage matrix.

FIG. 3B depicts an example of a simplified set of reserve duty patterns generated from the simplified coverage matrix of FIG. 3A.

FIG. 4 depicts an example trip schedule for a bid month from a case study using real world data.

FIG. 5 depicts an example matrix of expected reserve-demand data forecasted for the trip schedule of FIG. 4.

FIG. 6 depicts an charts representing aspects of a coverage solution generated by an implementation of the present disclosure from the case study using real world data.

FIG. 7 depicts charts representing the full coverage solution generated by an implementation of the present disclosure from the case study using real world data.

Like reference symbols in the various drawings indicate like elements.

### DETAILED DESCRIPTION

This specification relates to performing set cover optimization on complex logistical scheduling operations. Implementations are described herein in reference to the example context of airline reserve crew pattern optimization. However, implementations may be applicable to optimization modeling of other complex logistical scheduling such as warehouse operations, trucking operations, package delivery, etc.

Particular implementations of the subject matter described in this specification can be implemented so as to realize one or more of the following advantages. Implementations may provide more complete and accurate set coverage solutions for stochastic problems. For example, unlike the traditional method of generating patterns to cover the reserve demand one-to-one, this model designed patterns to cover reserve demand in many-to-many mode in a probabilistic way. Each selected pattern is not only generated for covering one set of trips without overlap but for covering some possible sets of trips with overlap between them. In this way, even the predicted reserve requirement of this type of trip will not occur, the pattern can still be used to cover other reserve demand. Implementations may provide improved error tolerance over existing deterministic optimization technologies. For example, many-to-many coverage modes may provide the model with high error tolerance which can reduce negative aspects of uncertainty in solving set cover problems such as airline reserve crew scheduling. Implementations, provide improved precision in estimating reserve demand scheduling. For instance, implementations employ reserve demand forecasting data that is structured on a trip-by-trip basis rather than on a daily basis; meaning that each reserve demand estimate value represents the expectation that a reserve crew will be required to cover an entire trip, which may span multiple consecutive days. Additionally, the reserve demand data is not rounded, e.g., to provide additional precision in scheduling.

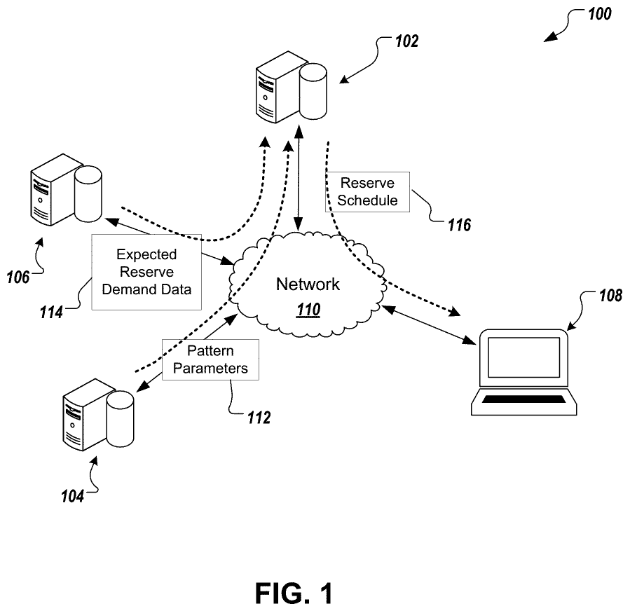

FIG. 1 depicts an example system 100 for executing implementations of the present disclosure. The system 100 includes an optimization system 102, a flight crew management system 104, a forecasting system 106, and one or more user computing devices 108. The optimization system 102 is in communication with the flight crew management system 104, the forecasting system 106, and the one or more user computing devices 108 through a network 110. The network 110 can include a large network or combination of networks, such as a local area network (LAN), wide area network (WAN), the Internet, a cellular network, a satellite network, one or more wireless access points, or any appropriate combination thereof connecting any number of mobile clients, fixed clients, and servers.

The optimization system 102, flight crew management system 104, and forecasting system 106 can each be implemented using one or more computing systems (e.g., servers). The computing systems can have internal or external storage components and can represent various forms of server systems including, but not limited to a web server, an application server, a proxy server, a network server, a user account server, or a server farm. Although illustrated as separate computing systems, in some implementations one or more of 102, 104, and 106 can be integrated into a single system. For example, the operations of the optimization system 102, flight crew management system 104, and forecasting system 106 can all be executed by the same computing system, such as a common server system.

The user computing devices 108 can include, but are not limited to, a laptop or desktop computer, a mobile phone, a smartphone, or a tablet computer.

As discussed herein, the optimization system 102 executes a set cover optimization model that is described in the context of generating reserve crew set coverage patterns for an airline. For example, in operation optimization system 102 can receive input data from the flight crew management system 104 and the forecasting system 106. The input data can include, but is not limited to, reserve pattern parameters 112 and expected reserve demand data 114. The optimization system 102 executes a set cover optimization model described herein based on the input data to generate a set of reserve crew duty patterns. A reserve duty schedule 116 can be created from the reserve crew duty patterns and provided to user computing devices 108.

For example, the forecasting system 106 can execute a forecasting tool (e.g., a forecasting tool in SAS Enterprise Guide) to estimate the reserve-demand data associated with airline trips scheduled over a particular time period (e.g., a bid month). The demand is the expected number of open time trips which is not necessarily an integer value. Implementations of this disclosure do not round the fractional reserve demand numbers. For instance, preserving the unrounded reserve demand estimate values retains valuable statistical information that is used by the scheduling systems described below. In addition, implementations employ reserve demand-data that is that organized in a per-trip basis, rather than a daily basis. That is, each value of expected reserve demand is associated with a regularly scheduled trip that may span several consecutive days, rather than being associated with, e.g., individual daily flights.

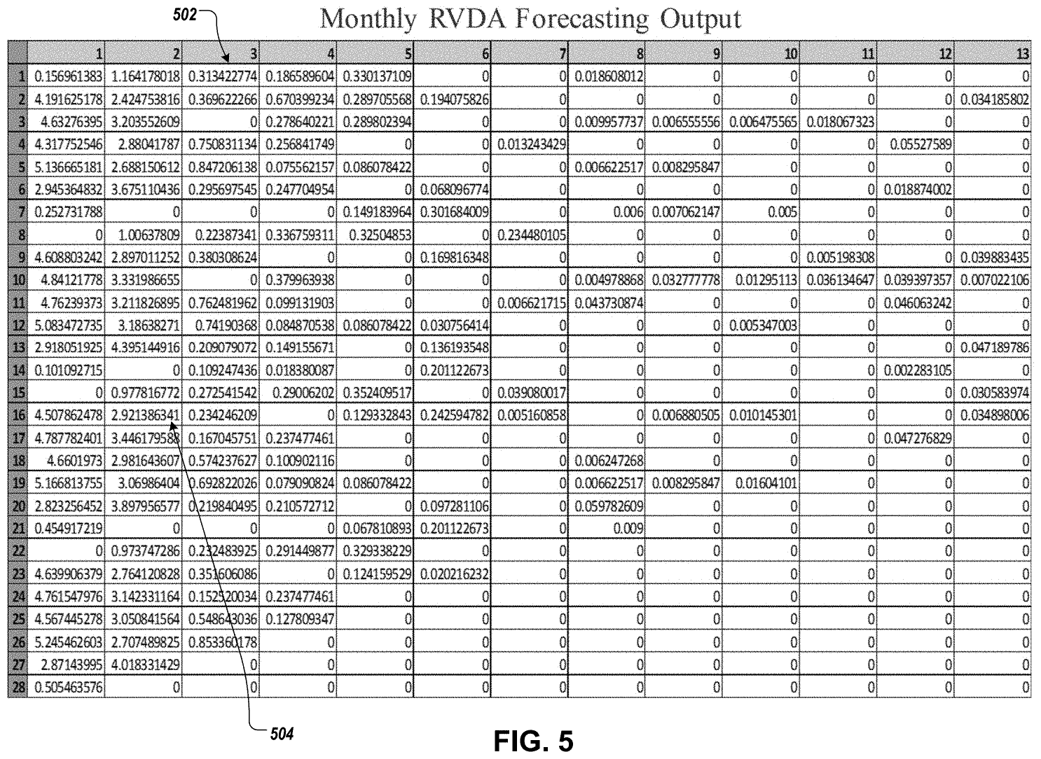

The reserve-demand data can be represented by a matrix D with d as the index (e.g., illustrated in FIG. 5), including all types of trips from the forecasting tool. The reserve-demand data is one input of the optimization model. The column of the matrix indicates the length of the trip type l and the row of the matrix indicates the starting date of trip t. The total number of days in the Bid Month is T and the element of the matrix n_{d} is the expected reserve demand of trip type (t, l)∈D. In some cases, multiple instances of the same type of trips are scheduled in a bid month and the n_{d} can represent the combined expected reserve demand for all of the trips of the same type (t, l). Consequently, the n_{d} can be fractional and can be less than 1 or greater than 1.

For example, as shown in FIG. 5, the trip (1, 3) (references numeral 502) indicates the trip is 3 days long and starts on day 1 of the Bid Month. The n_{d} for trip (1, 3) is 0.313422774, indicating that there is roughly a 31% A chance that a reserve crew will be needed to cover trip (1, 3). As another example, the trip (16, 2) (reference numeral 504) indicates the trip is 2 days long and starts on day 16 of the Bid Month. The n_{d} for trip (16, 2) is 2.92138634, indicating that there is roughly a 292% chance that a reserve crew will be needed to cover one of the trips (16, 2). In other words, there are multiple trips of type (16, 2) in the given bid month. For example, there may be six trips of type (16, 2) each of which may have a roughly 50% chance of requiring coverage by a reserve crew. Hence, the combined expected reserve demand for trip types (16, 2) in the given bid month is roughly 292%. Simply put, of the six trips of type (16, 2) is likely that three of the six will need to be covered by reserve crew.

In order to conveniently check if one reserve pattern i can cover a trip, a binary parameter is set as h_{d}^{t} to indicate the on-duty days of trip d. h_{d}^{t} is 1 if the trip d includes day t as an on-duty day, and is 0 otherwise. Based on h_{d}^{t}, the trip can be converted into a binary mode. Using the trip (17, 9) in a Bid Month which has 28 days (T=28) as an example, the trip can be represented by the following vector:

(0 0 0 0 0 0 0 0 0 0 0 0 0 0 0 0 1 1 1 1 1 1 1 1 1 0 0)

Building a set of reserve patterns to cover these expected levels of demand with as little as possible cost is the objective. Unlike regular line scheduled trips, the reserve patterns do not include any trips or pairings. Instead, they include blocks of consecutive on-duty days and blocks of consecutive off-duty days. The index P of pattern indicates the maximum total number of on-duty days in one bid period. Because of the special pay construct for reserve crew such that no matter how many days on operation they will be paid at least a Reserve Line Guarantee (RLG), as most as possible reserve days are expected to be included in the reserve pattern. Hence, the pattern includes the maximum on-duty days. In other words, P indicates the pattern's length unless the cost construct is changed.

The pattern type is traditionally defined to downsize the variable set. That is, in present systems, pattern type is commonly defined by the grouping of on-duty days and the groupings of the off-duty days. By determining the required number of each type of patterns the variable set can be reduced and increase the solving speed, and thus, the efficiency of optimization system 102. However, the type of pattern which is decided in advance becomes the parameter of the model. The limitation of the solution space exists in the meantime too since it is difficult to list all types of patterns. However, in the implementation of the present disclosure, the pattern is defined by more elements which means all legal pattern types can be included. For example, one pattern type is determined by the on-duty blocks type and the off-duty blocks type. On-duty blocks type is described by a vector variable, in which the number of elements is determined by how many on-duty blocks are in the pattern and the value of element is determined by the number of consecutive on-duty days in each block. Off-duty blocks is also a vector variable, in which the number of elements is determined by how many off-duty blocks are in the pattern. In some implementations, the off-duty blocks vector variable it is always equal to the number of elements in the on-duty blocks type plus one because on-duty blocks are positioned between two off-duty blocks. The value of elements in off-duty blocks type is determined by the number of consecutive off-duty days in each block. The total value of elements in on-duty block type plus the total value of elements in off-duty blocks type is equal to the total days in the bid period. By adjusting the element value in off-duty block can design the on-duty days block type with various number of elements.

Airlines may use different reserve pattern parameters 112 (e.g., rules) to build the legal reserve pattern. Reserve pattern parameters 112 generally include, but are not limited to, the length of pattern P and the minimum on-duty days in one block MB. Let K denote the maximum number of on-duty blocks. Hence, the number of off-duty blocks is K+1 with index k. Any block can be zero days long, but not all off-duty blocks are allowed to be zero at the same time. K can be calculated by dividing P by M and round it down to integer. For example, assuming that one airline allows the maximum length of pattern is 15 days and the minimum on-duty days in one block is 4 days, K can be simply calculated by rounding down 15/4, which is equal to 3 after rounding. The value of the element of off-duty blocks type yₖ is an integer including 0. The off-duty blocks type can be indicated as [y₁y₂, . . . , y_{K+1}]. If y₁ is 0, it means that the reserve pattern starts on the first Monday of the month. If y_{K+1} is 0, it denotes that the reserve pattern ends at the last Sunday of the month. If one yₖ, where k is neither equal to 0 nor K+1, is equal to 0, it denotes the number of on-duty blocks is K−1. If two yₖ, where k is neither equal to 0 nor K+1,are both equal to 0, it denotes the number of on-duty blocks is K−2 and the forth until only one on-duty block exist in pattern with P on-duty days . By this analogy, all on-duty block types with different number of elements from 1 to K can be identified. Let aₖ denotes the element value of on-duty blocks type.

For each pattern i, let binary variable Oᵢ^{t} denote which day is an on-duty day and which day is an off-duty day in a pattern. Pattern i has a total P on-duty days in a bid period which has T days. Oᵢ^{t} is 1 if day t is on-duty day in pattern i, is 0 if day t is off-duty day. An example duty pattern vector, Oᵢ, is shown below:

(0 0 1 1 1 1 0 0 0 1 1 1 1 0 0 0 0 0 1 1 1 1 1 1 1 0 0)

This sample pattern includes three on-duty blocks and four off-duty blocks. The on-duty blocks type is [4, 4, 7] and the off-duty blocks type is [2, 3, 5, 2]. The pattern type is [4, 4, 7]_[2, 3, 5, 2].

The quality of the reserve pattern is one aspect of controlling cost, since the uncovered cost rate of a trip is much more than the reserve cost rate. Generally, the longer reserve block has high availability when covering various open time trips has its limitation. In pre-existing scheduling models, no matter how much or few the occurring possibility of open time trips, when it is applied to a model as an input or parameter, it is always considered as the demand with 100% possibility because the smallest nonzero integer is 1. The example shown in Table 1 (below) is used to describe the limitation.

TABLE 1
Sample of Trip Coverage by Pattern.

| Date | Day 1 | Day 2 | Day 3 | Day 4 | Day 5 | Day 6 | Day 7 | Day 8 |
|---|---|---|---|---|---|---|---|---|
| Trip 1 | (0 | 1 | 1 | 1 | 0 | 0 | 0 | 0) |
| Trip 2 | (0 | 0 | 1 | 1 | 1 | 0 | 0 | 0) |
| Block 1 | [0 | 1 | 1 | 1 | 0 | 0 | 0 | 0] |
| Block 2 | [0 | 0 | 1 | 1 | 1 | 0 | 0 | 0] |
| Block 3 | [0 | 1 | 1 | 1 | 1 | 0 | 0 | 0] |

Trip 1 and Trip 2 are two open time trips that are needed to be covered in a bid period in which the first 8 days is are shown in Table 1. Trip 1 is (2, 3) and Trip 2 is (3, 3). There are three different reserve blocks available to build a reserve patterns. Block 1 can only cover Trip 1 and Block 2 can only cover Trip 2. Block 3 can cover both of the trips. However, a decision to user building Block 3 may not be optimal. Some assumptions need to be set first.

Assumption 1: The cost of these three blocks is the same even though they carry different on-duty days;

Assumption 2: Since the length of Trip 1 and Trip 2 are the same, their uncover cost is the same;

Assumption 3: Trip 1 and Trip 2 have equal likelihood to be dropped out and become open time trips.

With these three assumptions, one can say that if only one block can be selected, Block 3 is always the best choice. If Trip 1 and Trip 2 occur more than once and two blocks can be used, building two patterns with Block 3 may be a good decision.

However, in real world practice, these assumptions may not always be satisfied. For example, the pattern may include 12 days or more and other on-duty blocks, which are not shown in Table 1, which can be used to cover other trips that start after day 8. Assume, for example, one 9 days trip that starts on day 9 needs to be covered, if Block 1 or Block 2 is used, although one 3-day trip may not be covered, there are 9 on-duty days left, that can be built to cover that long trip. Instead, Block 3 has the chance to cover trip 1 and trip 2, but if it is selected, there are not enough on-duty days left to cover the 12-day long trip and it can't be used to cover both Trip 1 and Trip 2 at the same bid period in daily operations. In this scenario, the cost of an on-duty block is related to the block length, although the cost of the reserved duty pattern is the same.

Examples with more complex conditions are shown in Table 2 (below). Trip 1 (2, 3) and Trip 3 (4, 5) are two possible open time trips. Block 1, Block 4 and Block 5 can be built to cover these two trips. Block 1 can only cover Trip 1, Block 4 can only cover Trip 3 and Block 5 can cover both of these two trips.

TABLE 2
Another Sample of Trip Coverage by Pattern.

| Date | Day 1 | Day 2 | Day 3 | Day 4 | Day 5 | Day 6 | Day 7 | Day 8 |
|---|---|---|---|---|---|---|---|---|
| Trip 1 | (0 | 1 | 1 | 1 | 0 | 0 | 0 | 0) |
| Trip 3 | (0 | 0 | 0 | 1 | 1 | 1 | 1 | 1) |
| Block 1 | [0 | 1 | 1 | 1 | 0 | 0 | 0 | 0] |
| Block 4 | [0 | 0 | 0 | 1 | 1 | 1 | 1 | 1] |
| Block 5 | [0 | 1 | 1 | 1 | 1 | 1 | 1 | 1] |

TABLE 3
Sample Cases of Occurring Possibility.

| | Case 1 | Case 2 | Case 3 | Case 4 | Case 5 |
|---|---|---|---|---|---|
| Trip 1 | 0.9 | 0.4 | 0.5 | 0.8 | 0.67 |
| Trip 3 | 0.2 | 0.8 | 0.5 | 0.7 | 0.58 |

The length of trips is not the same and the length of blocks are different. In Case 1 at the first column of Table 3, the occurring likelihood of open time Trip 1 is 90% and 20% for Trip 3. Is Block 5 still the best choice? In other words, is it worth adding 4 days to the block to cover Trip 3? Block 5 may be a better choice than Block 4 and is clearly a better choice than Block 1. In Case 2, at the second column, the occurring likelihood of open time Trip 1 is 40% and 80% for Trip 3. Is it worth the 2 day increase of Block 5 to cover Trip 1? At least, there is a higher confidence to select Block 5 in this case than in Case 1, because 0.4×3 is greater than 0.2×5. In other words, the possible uncovered cost should be considered. In Case 3, at the third column, both occurring likelihood is 50%. It appears more reasonable to select Block 5 rather than Block 1 or Block 4. In Case 4, at the fourth column, the occurring likelihood of open time Trip 1 is 80% and 70% for Trip 3. Block 1 and Block 4 may both be selected to cover Trips 1 and 3 if the capacity of reserve crew allows. In Case 5, at the last column, the occurring likelihood of open time Trip 1 is 67% and 58% for Trip 3. It is difficult to decide how to select a block in this kind of case without any mathematical model's support. Real-time situations can be much more complex than the cases in this example because they need to compare the full pattern but not only blocks. The size of open time trips and patterns are much greater than what is in these examples in Tables 1-3. The optimization model discussed below addresses these and other technical problems.

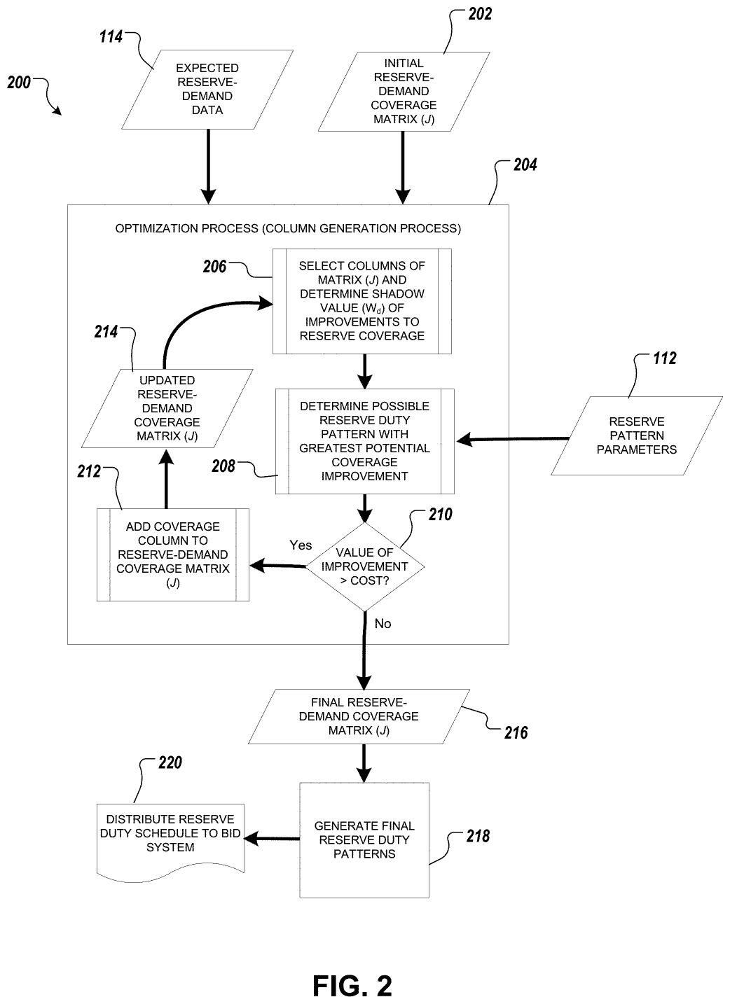

FIG. 2 depicts a flowchart of an example reserve crew optimization process 200 that can be executed in accordance with implementations of the present disclosure. In some implementations, the process 200 can be provided as one or more computer-executable programs executed using one or more computing devices. In some examples, the process 200 is executed by a system such as optimization system 102 of FIG. 1. In some implementations, all or portions of process 200 can be performed on a local computing device, a desktop computer, a laptop computer, or a tablet computer. In some implementations, all or portions of process 200 can be performed on a remote computing device, a server system or a cloud-based server system.

Process 200 represents an optimization model for solving reserve scheduling problems discussed above. Process 200 may reduce the total reserve cost which includes two main costs: one is reserve crew cost and the other is the cost of uncovered trips. Let c denote the cost of one pattern and s_{d} is the unit cost of an uncovered demand of trip d, which is related to the trip length. The cost of uncovered trip d (l, t) is s_{d}×l. The approach integrated the reserve forecasting stage into the optimization stage by keeping expected levels of demand. If an expected demand level is less than 1, it can be viewed as an occurrence likelihood or possibility. This information can improve the quality of reserve patterns such as by increasing the availability when covering open time trips in the daily operation stage.

To begin process 200, the system obtains optimization model input data. For example, the system can receive expected reserve demand data 114 from a forecasting system 106. As discussed above, the expected reserve demand data can include, but is not limited to, forecasting data that associates a plurality of airline trips with and is expected reserve demand value. For example, the expected reserve demand data 114 can be an expected reserve demand matrix that associates a plurality of airline trips with an expected reserve demand value which indicate the probability that each airline trip will require coverage by reserve crew. Similarly, the system can receive reserve pattern parameters 112 from a flight crew management system 104. As discussed above, the reserve pattern parameters 112 can include, but are not limited to, a reserve pattern length (P) and a minimum number of on-duty days per duty block (MB).

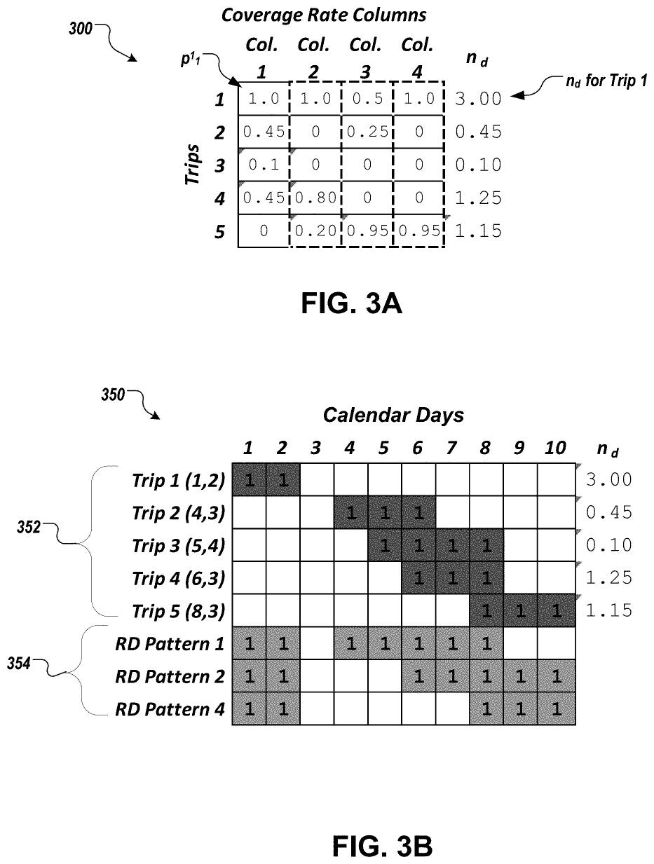

The system generates a reserve demand coverage matrix 202. For example, the system can introduce into the optimization model a matrix 202 referred to as “Coverage” or Coverage Matrix 202. FIG. 3A depicts a simplified example of a coverage matrix 202 (e.g. simplified coverage matrix 300). In general, coverage matrix 202 provides a probability (or rate) at which a given reserve pattern can be used to cover corresponding trips.

For example, let J denote the coverage matrix 202 with the set of all possible coverages over all open time trips with j as index. One coverage column j is a vector of |D| elements (e.g., the total number of scheduled trips) that are in one-to-one correspondence with the pattern. Each element of the coverage matrix 202 is the probability (or rate) that pattern i (corresponding to column j of the coverage matrix 202) may be used to cover open time trip d and is denoted by pⱼ^{d}. The value of pⱼ^{d} is in the range [0, 1]. This many-to-many coverage model may provide more robust and efficient reserve coverage patterns. Specifically, many-to-many coverage is permitted by the coverage matrix 202. Many-to-many coverage refers to the ability to use more than one reserve pattern to cover a trip (according to an associated coverage rate), and the ability to have one reserve pattern provide partial (less than 100%) coverage for more than one trips on a given calendar day. For example, as depicted in simplified coverage matrix 300, a reserve pattern based on coverage column 1 would be able to cover trip 1 100% of the time that reserve crew coverage is required for trip 1, to cover trip 2 45% of the time that reserve crew coverage is required for trip 2, to cover trip 35% of the time that reserve coverage is required for trip 3, to cover trip 450% of the time that reserve coverage is required for trip 4, and would be unable to cover trip 5.

The process 200 employs a column generation process 204 to build qualified reserve patterns. The model input data 112, 114 and coverage matrix 202 are applied as inputs to the column generation process 204. A sub-problem (described below) is built to ensure that all open time trips that can be covered by pattern i are considered in the optimization process. Additionally, all patterns can be used to cover open time trip d are compared in process to. q_{d} is used to indicate the possibility of the coverage of pattern i to trip d. Each possible pattern i is featured by a vector with T elements of binary values Oᵢ^{t}.

The binary variable xⱼ equals 1 to represent that coverage column j is selected, or equals to 0 otherwise. The non-negative variable u_{d} represents the amount of uncovered open time trip demand d. The master problem of the optimization model can be described as follows:

### Master Problem:

$$\begin{matrix}Min c {\sum }_{j ∈ J} {x}_{j} + {\sum }_{d ∈ D} {s}_{d} {u}_{d} & ( 1.1 ) \\ Subject To \text{:} & \\ \begin{matrix}{\sum }_{j ∈ J} {p}_{j}^{d} {x}_{j} + {u}_{d} & ∀ d\end{matrix} & ( 1.2 ) \\ {x}_{j} ∈ \{ 0 , 1 \} ; {u}_{d} \geq 0 & ( 1.3 )\end{matrix}$$

The master problem (1.1-1.3) is a set cover problem and it is always feasible because of the existence of u_{d}. Constraint set (1.2) describes how the subset of coverage covers the reserve demand. When set J includes enough numbers of all possible coverage, the master problem can yield the best solution. In order to make the problem tractable, columns (associated with xⱼ) are iteratively created, following the column generation procedure. When its linear relaxation (e.g., xⱼ∈[0,1]) is solved to its optimality, the shadow value (e.g., shadow price) of constraint d (denoted by w_{d}) can be determined.

For each possible reserve pattern, process 200 uses the sub-problem (defined below) to calculate a potential improvement value (vₘ−c) of the pattern, where c represents the cost of an additional reserve pattern and vₘ represents an amount of reduction the cost of uncovered trips that can be provided by reserve pattern m. The improvement value (vₘ−c) represents the potential cost improvement that a given pattern will provide to the overall optimization model as governed by the master set cover problem. In order to reduce the solving time, the set of all possible reserve duty patterns, l, is generated in the sub-problem. Variable rₜ^{f} is used to locate all the on duty days in the bid period. rₜ^{f} is 1, if day t is the fth on duty day in this pattern, and is 0 otherwise.

### Sub-Problem:

$$\begin{matrix}{v}_{m} = max {\sum }_{d ∈ D} {w}_{d} {q}_{d} & & ( 1.4 ) \\ Subject To \text{:} & & \\ {\sum }_{d = 1}^{D} {h}_{d}^{t} {q}_{d} \leq {O}_{i}^{t} & ∀ t & ( 1.5 ) \\ {q}_{d} \leq {n}_{d} & ∀ d & ( 1.6 ) \\ {\sum }_{t = 1}^{T} {O}_{i}^{t} = P & & ( 1.7 ) \\ {\sum }_{k = 1}^{K + 1} {y}_{k} = T - P & & ( 1.8 ) \\ {\sum }_{t = 1}^{T} {r}_{t}^{f} = 1 & ∀ f & ( 1.9 ) \\ {O}_{i}^{t} = {\sum }_{f = 1}^{P} {r}_{t}^{f} & ∀ t & ( 1.10 ) \\ {\sum }_{t = 1}^{T} {r}_{t}^{f} t = {y}_{1} + 1 & ∀ f = ( 1 , 2 , … , {a}_{1} ) & ( 1.11 .1 ) \\ {\sum }_{t = 1}^{T} {r}_{t}^{f} t = {y}_{1} + {a}_{1} + {y}_{2} + 1 & ∀ f = ( {a}_{1} + 1 , {a}_{1} + 2 , … , {a}_{1} + {a}_{2} ) & ( 1.11 .2 ) \\ \begin{matrix}{\sum }_{t = 1}^{T} {r}_{t}^{f} t = {y}_{1} + {a}_{1} + {y}_{2} + \\ {a}_{2} + {y}_{3} + 1\end{matrix} & \begin{matrix}∀ f = ( {a}_{1} + {a}_{2} + , {a}_{1} + \\ {a}_{2} + 2 , … , {a}_{1} + {a}_{2} + {a}_{3} )\end{matrix} & ( 1.11 .3 ) \\ ⋮ & ⋮ & ⋮ \\ {\sum }_{t = 1}^{T} {r}_{t}^{f} t = {\sum }_{k = 1}^{K} {y}_{k} + {\sum }_{k = 1}^{K - 1} {a}_{k} + 1 & \begin{matrix}∀ f = ( {a}_{1} + {a}_{2} + … + {a}_{K - 1} + 1 , \\ {a}_{1} + {a}_{2} + … + {a}_{K - 1} + \\ 2 , … , {a}_{1} + {a}_{2} + … + {a}_{K} )\end{matrix} & ( 1.11 . K ) \\ 0 \leq {q}_{d} \leq 1 , {r}_{t}^{f} , {O}_{i}^{t} ∈ \{ 0 , 1 \} , & {y}_{k} \geq 0 integer & ( 1.12 )\end{matrix}$$

The largest vₘ is selected to create a new column in the master problem with the coefficient vector of q_{d.} m denotes the element of set M which includes all legal on-duty blocks types (e.g., all on-duty block types that meet the minimum number of on-duty days per duty block (MB). Constraint set (1.5) describes that each duty day in trip d is also on-duty day in pattern i if pattern i is selected as a potential coverage to trip d. Constraint set (1.6) ensures that the coverage of trip d is not greater than its demand. The remaining constraints are all for building reserve patterns. Constraint (1.7) and (1.8) set the reserve pattern's length and the total off-duty days. Constraint set (1.9) ensures the fth on-duty days of the pattern only locate at one day. Constraint set (1.10) is used to locate all on-duty days at Bid calendar. Constraint sets (1.11) has K constraint sets describing each on-duty blocks in pattern i.

In brief, the overall algorithm can be described as follows:
Step 206: Solve master problem (1.1-1.3) with xⱼ∈[0,1] to get w_{d}.
Step 208: Solve all sub-problem (1.4-1.12) for all m (legal on—duty block types)∈I (all resever patterns) and get vₘ.(improvement value of each pattern type) to find the reserve pattern with the largest value of vₘ. (identify new reserve pattern with highest value).
Step 210: If the largest vₘ is not greater that c (cost of an additional pattern), stop and go to 218.
Step 212: Insert the new coverage column featured by q_{d} (trial coverage rate of pattern m) corresponding to the largest vₘ into J with the new pⱼ^{d}=q_{d}. Go to step 206.
Step 218: Solve master problem with xⱼ∈{0,1}.

In more detail, the system determines a shadow value of improvements to reserve coverage (206). For example, the system can determine a shadow value (w_{d}) for each type of trip (d) of the reserve demand matrix (D). In some examples, the system can determine shadow values by solving the master problem above using relaxed constraints. For example, by relaxing the constraint on xⱼ with xⱼ∈[0,1] rather than with xⱼ∈{0,1}. In other words, the system can solve the master problem as a linear problem (LP) with xⱼ permitted to take linear values within the range of 0 and 1, rather than an integer problem (IP). In some implementations, the system can perform the master problem and obtain shadow values by using an optimization solver, e.g., the Gurobi solver, IBM ILOG CPLEX, and Cardinal Optimizer.

The system determines a possible reserve duty pattern with the greatest potential coverage improvement (208). For example, the system can identify a possible reserve duty pattern from among all potential (e.g., legal according to the reserve pattern parameters 112) reserve duty patterns that has the greatest potential coverage improvement for addition to the coverage matrix 202. For example, the system can execute the sub-problem discussed above in order to determine a plurality of possible reserve duty patterns. The system can calculate an improvement value (vₘ) for each of the possible reserve duty patterns based on the shadow values determined from the master problem (e.g., step 206). As described by equation (1.4), the improvement value for each reserve pattern can be determined based on respective shadow values of potential trips covered by the reserve pattern and a trial coverage rate (q_{d}) with which the reserve pattern would cover the potential trips. The system can identify a particular reserve duty pattern that has the highest improvement value from among the possible reserve duty patterns.

In some implementations, the system uses a tiered approach to determine the possible reserve duty pattern with the greatest potential coverage improvement. For example, the system can cycle through each legal on-duty block types m of set M of all legal on-duty blocks types identifying the highest value pattern within each block type m.

For example, assume that the length of a reserve pattern is 15 days, so that the total off-duty days are 28−15=13. Each on-duty day block includes at least 4 reserve days (e.g., MB=4), so that the maximum number of on-duty blocks K is 3. There will be a total of 16 legal on-duty blocks types M listed as follows: [4, 4, 7]; [4, 7, 4]; [7, 4, 4]; [4, 5, 6]; [5, 4, 6]; [6, 5, 4]; [5, 5, 5]; [4, 11]; [11, 4]; [7, 8]; [8, 7]; [6, 9]; [9, 6]; [5, 10]; [10, 5]; and [15]. Each of these 16 legal block types can be distributed in multiple different patterns among the days of a given bid month.

The system can determine the pattern of block type m=1 (e.g., block type [4, 4, 7]) that provides the greatest potential coverage improvement and store the value as vi. For example, the system can calculate the improvement value for each possible pattern of block m=1 (e.g., block type [4, 4, 7]) using equation (1.4) and identify the pattern that provides the maximum value. The system can store the identified block type m=1 pattern and its associated improvement value (e.g., v₁). Then the system and perform the same process for block type m=2 (e.g., block type [4, 7, 4]), and so on until all each of the legal block types in set M have been evaluated.

The system compares the respective improvement values (vₘ) for each legal block type to identify the possible reserve duty pattern with the greatest potential coverage improvement. In some implementations, the system completes the evaluation of each legal block type before comparing all of the stored improvement values (vₘ) to identify the pattern with the maximum improvement value. In some implementations, the system compares improvement values (vₘ) on an ongoing basis as each legal block type m is evaluated. For example, after the second block type (m=2) is evaluated to improvement value (v₂), the system can compare the stored value of improvement value v₁ with the value of v₂ The system can store the greater of the two values along with the associated reserve pattern. The system can then repeat the process for each subsequent legal block type; storing only the pattern with the higher improvement value (vₘ) until all of legal on-duty block types in the set M have been evaluated. The remaining stored reserve pattern will then be one with the maximum improvement value (vₘ).

The highest improvement value (e.g., max vₘ) can be compared to a stop criteria (210), for example, to determine whether the column generation process 204 is complete and can be stopped, or whether additional columns should be generated. For example, the stop criteria can be a cost (c) of adding an additional reserve pattern to a reserve schedule. If the improvement value of the identified reserve pattern is greater than the cost to add the reserve pattern to reserve schedule the column generation process (204) proceeds to step (212). If the improvement value of the identified reserve pattern is less than the cost to add reserve pattern to reserve schedule the column generation process (204) is complete, and the optimization process 200 proceeds to step (218).

At step (212), a coverage column associated with the reserve pattern having the highest improvement value is added to the coverage matrix 202. For example, the coverage 202 is updated by adding the new coverage column. The updated version of the coverage matrix (e.g., updated coverage matrix 214) is then used in step 206 to perform a subsequent iteration of the column generation process (204). For example, in reference to the simplified coverage matrix 300 of FIG. 3A, the improvement value of reserve patterns associated with coverage columns 2, 3, and 4 may have been greater than the cost of adding the associated reserve patterns to a schedule. Consequently, each of coverage columns 2, 3, and 4 would be added to the simplified coverage matrix 300 during respective iterations of the column generation process (204). For example, when a coverage column is added to the coverage matrix 202 the new coverage column (e.g., column 2 of the simplified coverage matrix 300 in FIG. 3A) is generated from the trial coverage rate of the selected reserve pattern. That is, the selected reserve pattern being the particular reserve pattern that was identified as having the highest improvement value for a particular iteration of the column generation process (204).

In some implementations, the system can add multiple columns to the coverage matrix 202. For example, the system can add multiple (e.g., two or more) new columns to the coverage matrix 202 during each iteration of the sub-problem, so long as the added columns each have an improvement value that does not satisfy the stop rule (e.g., v_{each column} is not greater that c). In some examples, the system can add the best generated pattern for each legal pattern type as new columns in the coverage matrix 202. The best pattern for each legal pattern type may be evaluated as the pattern with the highest improvement value of each legal pattern type. In some implementations, the system can add a predetermined number of new patterns (e.g., 5, 10, 15, etc.). For example, the system can add the top five patterns as columns to the coverage matrix 202 (e.g., the patterns with the five highest improvement values).

At step (218), the system uses the final reserve-demand coverage matrix 216 to generate a final set of reserve duty patterns. For example, the final reserve-demand coverage matrix 216 is the coverage matrix 202 containing all of the coverage columns (e.g., columns 2-4 in the simplified matrix 300 of FIG. 3A) that have been added during the column generation process (204). For example, the system can generate a final set of reserve duty patterns by executing the master problem with full constraints (e.g., xⱼ∈{0,1}) using the final reserve-demand coverage matrix 216.

For instance, in reference to the simplified coverage matrix 300 of FIG. 3A, executing the master problem to generate the final reserve duty patterns (218) may result in coverage columns 1, 2, and 4 being selected from the simplified coverage matrix 300 as the optimal reserve coverage solution. By way of example, such a solution to the master problem would generate an xⱼ vector of: [1 1 0 1], when the master problem is solved as an integer problem with full constraints. The system can translate the selected columns of the final version of the reserve demand coverage matrix 216 to generate the final set of reserve duty patterns.

For example, FIG. 3B depicts an example of a simplified set of reserve duty patterns 354 generated from the simplified coverage matrix 300 of FIG. 3A. Chart 350 illustrates the coverage that reserve duty patterns 1, 2, and 4 provide for trips 1-5 over the course of 10 calendar days. Together the selected reserve duty patterns 354 provide complete coverage for the trips 352 in the simplified bid month according to the respective expected reserve demand of each trip (n_{d}). It's for example, on days 1 and 2 each of reserve duty patterns 1-3 are available to cover trip one if the need arises. On day 4 reserve duty pattern 1 is available to cover trip 2 if needed. On day 5 reserve duty pattern 1 is available to cover trips 2 and 3 with coverage rates of 0.45 and 0.1 respectively. On calendar day 6 reserve duty patterns 1 and 2 are available to cover trips 2, 3, and 4. More specifically, on day 6 reserve duty pattern 1 is available to cover trips 2 and 3 with a combined coverage rate of 0.55, and is also available to cover trip 4 with a coverage rate of 0.45. However, trip 4 has an expected reserve coverage of 1.25, so reserve duty pattern 2 is available to cover trip 4 with the coverage of 0.8. In other words, reserve duty pattern 2 will cover trip 4 80% of the time. On days 8-10 reserve duty pattern to is also available to cover trip 5 with a coverage of 0.2 and reserve duty pattern 4 is available to cover trip 5 with a coverage of 0.95.

In some examples, solution of this optimization process 200 not only includes the set of selected reserve patterns and the uncovered trips but also the set of open time trips covered by each selected pattern and all patterns that can be used to cover each open time trips. Two situation of coverage of reserve demand may exist. One is that the demand is covered by fewer patterns but with high enough possibility compared with the value of expected demand. Another situation is the open time trips can be covered by more patterns with relatively low possibility of coverage for each pattern. In this situation, although the possibility of one coverage is low, it can be covered by more patterns which makes it still have a good chance to be covered based on the level of expected demand.

In some implementations, additional or alternative constraints can be added to the model based on the different reserve pattern parameters (e.g., reserve scheduling rules) in different airlines. For example, the capacity of reserve crew can be added to the master problem which is formulated as follows. However, it is not always necessary to be included because the optimization model can give a set of reserve patterns to be assigned to reserve crew. This set is the optimal solution the model found, the number of reserve patterns can be a suggestion to schedulers and they can adjust the other group of crew to find some crew to carry them. There are a lot of ways to improve the reserve crew management. For example, if a long range of reserve crew management is not good, the capacity of reserve crew in pre-month planning stage will be influenced. The optimal solution is restricted by the capacity.

Another improvement example that can be given is assignment policy in daily operations. A good assignment policy that suits the design of patterns will benefit the coverage effect of patterns as much as possible. In some implementations, the master problem can be repeated using hybrid forecasting data. For example, the master problem can be repeated during a bid month to adjust reserve crew assignments as the bid month progresses. The forecasting data can be updated with actual trip data as regularly scheduled trips are either executed as planned or canceled and covered by a reserve crew. For example, referring to FIG. 3B, if Trip 2 flies as scheduled with the regularly scheduled crew the forecasting data associated with Trip 2 can be replaced by actual data indicating that the trip was executed as scheduled (e.g., Trip 2's n_{d} may be replaced with a zero indicating that the trip does not need to be covered by a reserve crew). The actual data for Trip 2 releases the need for reserve pattern (RD pattern 1) to possibly cover Trip 2, thus making it available to cover other trips. Consequently, re-running the master problem would re-assign RD pattern 1 to another trip that may yet require reserve coverage. To re-assign trips during a bid month, the master problem can be run routinely (e.g., daily, weekly, etc.) using the final reserve-demand coverage matrix 216 and the hybrid forecasting data. In such situations, the master problem can be run using as an integer problem with full constraints (e.g., xⱼ∈{0,1}), which reduces the computing resources and time required to generate the re-assignments.

$${\sum }_{j ∈ J} {x}_{j} \leq W \qquad ( 1.13 )$$

A multi-stage stochastic optimization process is developed to decide if any trip can be dropped or not. When daily operations stage begins, reserve assignment process starts in the meantime. For each day of the bid period, the number of each open time trip types become as known information. After assigning them to some crew's reserve line, the value of the parameters of the optimization model such as the reserve demand matrix can be updated. The set of patterns obtained from the column generation algorithm becomes fixed input data after removing the reserve days which have assigned trips to and the ones which are released based on regulation.

Rerunning the optimization model with these updated parameters, the system can update the coverage to provide assignment suggestions for the next stochastic stage. A list of allowed dropping reserve days is given, in which the days dropped with high influence of coverage will be listed at the top. The pattern in higher order should be protected better. Some policies can be considered in assignment process when a set of feasible reserve blocks are found with long enough on-duty blocks for covering the open time trip:
1) Select the shortest ones in this set. Perfect match is the best.
2) If there is more than one block satisfied, select the one which has more unused reserve days or less duty hours before.
3) If there is still more than one block satisfied, consider if this long pattern should be saved for a long trip with relevant high possibility.

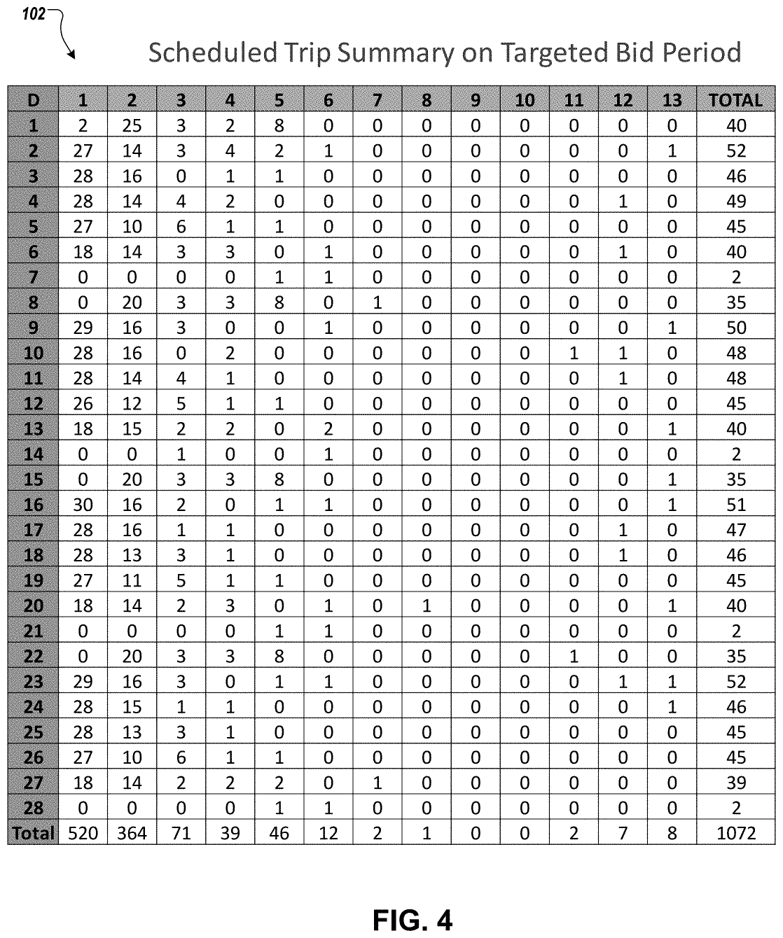

FIGS. 4-7 represent data from an experimental cases study performed with a major U.S. air carrier. One 4-week Bid Month is randomly selected as a target. The total number of days in the Bid Month T is 28. The range of trip length is from 1 to 13. The scheduled trips of this bid period are stored in a matrix shown as in FIG. 4 which is used as the input of reserve forecasting system 106. FIG. 5 illustrates the expected reserve demand matrix D for the trips shown in the schedule matrix of FIG. 4.

For example, assume that the length of a reserve pattern is 15 days, so that the total off-duty days are 28-15=13. Each on-duty day block includes at least 4 reserve days (e.g., MB=4), so that the maximum number of on-duty blocks K is 3. The legal on-duty blocks types M are listed as follows: [4, 4, 7]; [4, 7, 4]; [7, 4, 4]; [4, 5, 6]; [5, 4, 6]; [6, 5, 4]; and [5, 5, 5]. There are 4 off-duty blocks. When one block between two on-duty blocks is 0, the number of on-duty blocks is reduced to 2. If both off-duty blocks between on-duty blocks are 0, the pattern becomes a 15-day long pattern which only has one on-duty block. By setting the off-duty blocks, all qualified on-duty blocks types with less than 3 on-duty blocks are created in model such as: [4, 11]; [11, 4]; [7, 8]; [8, 7]; [6, 9]; [9, 6]; [5, 10]; [10, 5] and [15].

The cost of awarding one reserve pattern to crew was assumed as 100 and the uncover cost for the trip per day is 15. The constraints used to generate the patterns in the sub-problem of model are shown as follows:

$$\begin{matrix}{y}_{1} + {y}_{2} + {y}_{3} + {y}_{4} = 13 & & ( 1.14 ) \\ {\sum }_{t = 1}^{T} {r}_{t}^{f} = 1 & ∀ f & ( 1.15 ) \\ {\sum }_{t = 1}^{T} {O}_{i}^{t} = 15 & & ( 1.16 ) \\ {O}_{i}^{t} = {\sum }_{f = 1}^{P} {r}_{t}^{f} & ∀ t & ( 1.17 ) \\ {\sum }_{t = 1}^{T} {r}_{t}^{f} t = {y}_{1} + 1 & ∀ f = ( 1 , 2 , … , {a}_{1} ) & ( 1.18 .1 ) \\ {\sum }_{t = 1}^{T} {r}_{t}^{f} t = {y}_{1} + {a}_{1} + {y}_{2} + 1 & ∀ f = ( {a}_{1} + 1 , {a}_{1} + 2 , … , {a}_{1} + {a}_{2} ) & ( 1.18 .2 ) \\ \begin{matrix}{\sum }_{t = 1}^{T} {r}_{t}^{f} t = {y}_{1} + {a}_{1} + \\ {y}_{2} + {a}_{2} + {y}_{3} + 1\end{matrix} & \begin{matrix}∀ f = ( {a}_{1} + {a}_{2} + 1 , {a}_{1} + {a}_{2} + \\ 2 , … , {a}_{1} + {a}_{2} + {a}_{3} )\end{matrix} & ( 1.18 .3 )\end{matrix}$$

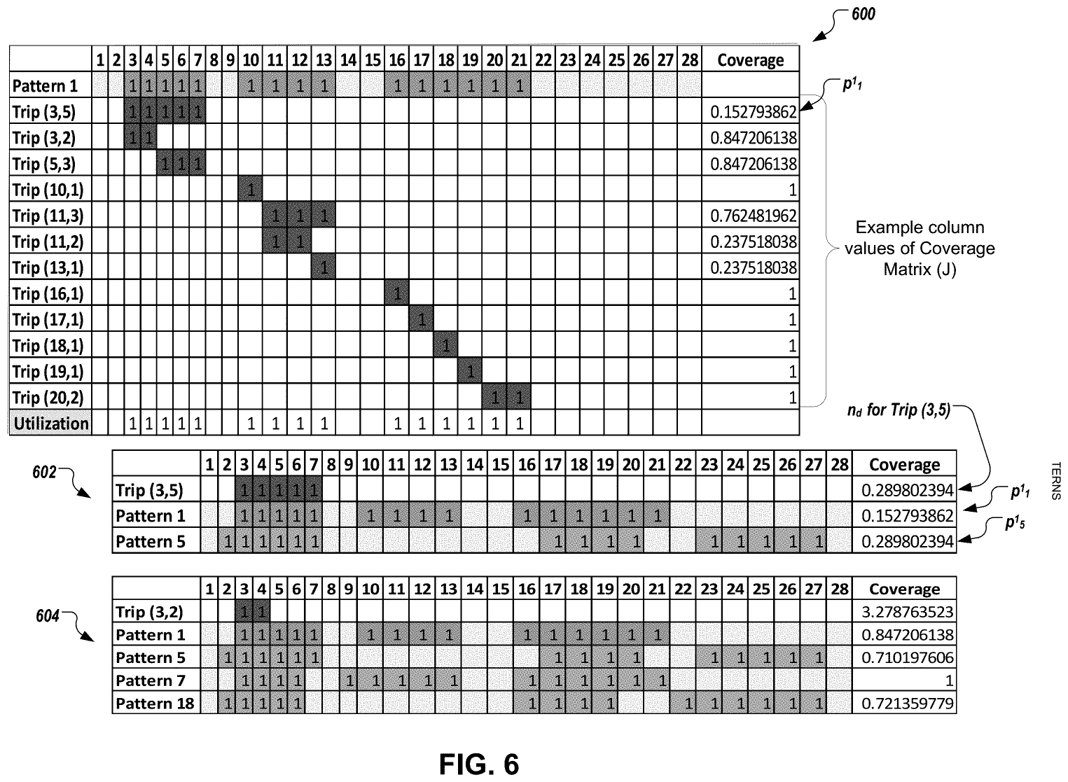

FIG. 6 chart 600 is one of the patterns in the solution. Columns denote the days in 4-week Bid Month. The first row is the pattern generated by the model the pattern type of which is [5, 4, 6]_[2, 2, 2, 7]. The element with 1 in it indicates an on-duty day and nothing indicates an off-duty day. Each row, except the first one and the last one, indicates one open time trip that needs to be covered in in forecasted reserve demand. As shown, twelve trips are forecasted to be covered by this pattern. For each on-duty day in the pattern, the total coverage stored in the row named “Utilization” is never greater than 1. The last column indicates the possibility of using the pattern to cover this trip. If the number of coverage is 1, no other trips existing in this matrix has overlap with it such as Trip (16, 1), Trip (17, 1) and Trip (20, 2). If the coverage is less than 1, overlap is allowed to exist and the total should be 1 or less. Trip (3, 5) and Trip (3, 2) have overlap which indicates that the possibility of using this pattern to cover Trip (3, 5) is 15.28% and the possibility of using this pattern to cover Trip (3, 2) is 84.72%. If both trips require reserve coverage, Pattern 1 can only be used to cover one of them, but there are other patterns that can cover them as shown in FIG. 6 chart 602 and FIG. 6 chart 604. The total coverage of each trip is based on the forecast demand of it. When one open time trip occurs, all available patterns that can cover this trip should be compared and selected.

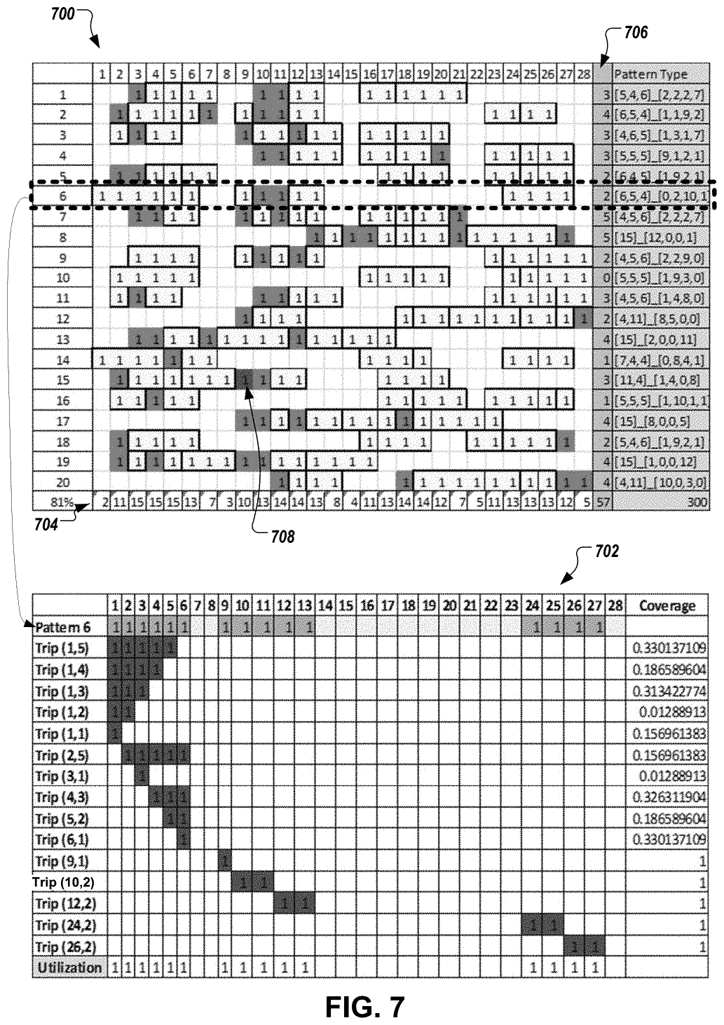

FIG. 7 chart 700 illustrates the coverage solution generated by process 200 (discussed above) which includes 20 patterns (e.g., pattern lines 1-20 shown in rows 1-20) after the reserve assignment process. The open time trips are from the real historical data of this Bid month. Assignment process follows the time line assigning the trips once a day. In some examples, the following criteria can be considered when assigning trips:
1) Long trip is assigned first when comparing all open time trips which starts on the same day;
2) Assign the one which has been unused more days first;
3) Do not assign trip that is more than one day long to the pattern if it has a high possibility of being used to cover a long trip in future days.

Each row, except the last one, illustrates one reserve pattern (also referred to as a “pattern line”). Columns, except the last two, denote the days in a four-week Bid Month. Chart cells with “1” in indicate on-duty days and chart cells with nothing indicates off-duty days. Dark shaded cells indicate unused reserve days and lightly shades cells indicated reserve days that are assigned to a regularly scheduled trip. The bold frame illustrates the length of an assigned trip. The numbers in row 704 indicate the total available patterns on each day of the Bid month and the numbers in column 706 indicate the total unused days of the pattern. As shown, the minimum number in column 706 is 0 and the maximum number is 5. Hence, the utilization for each pattern is in the range of 67% to 100%. The total unused reserve days are 57 which make the average utilization of reserve patterns is 81%.

Fifty days in 293 reserve demand are decided not to be covered by reserve patterns, so the coverage is end up with 82.935%. There are two reasons for uncovering patterns; one is high possibility but too short to use a 15 day pattern to cover. The other is with low occurring possibility.

FIG. 7 chart 702 illustrates the predicted coverages of pattern 6 of the solution of the model and the result after assigning trips. Pattern 6 in the dashed frame of chart 702 is match with it. As shown, the usage of pattern 6 is almost perfect. Only Trip (10, 2) is not assigned to it which is forecasted to occur. Actually, there is open time Trip (10, 2) that needs to be covered in daily operations. The reason why it is not assigned to Pattern 6 is in comparing all available patterns, there are other patterns which include more unused days prior. In order to balance the vacancy rate, this trip is decided to be assigned to pattern 3.

For the case study the optimization model was run on an HP EliteBook 820 server running i5-4300U CPU. The Gurobi 6.0.4 is used to solve this test instance in Pyhthon. Linear (relaxed constraint) problem is solved in 227 minutes generating 512 reserve patterns. The optimal cost is 2039.15. The integer problem provides a good solution in 1312 seconds and the cost is 2301.93. Some more case studies are done for different fleet and bid period. The results are shown in Table 4.

TABLE 1
Solution of Case Studies.

| | Number | | | | | |
|---|---|---|---|---|---|---|
| | of | Short | | Long | | |
| | Scheduled | trip | Medium | trip | | |
| | Trips | (<3) | trip | (>4) | Utilization | Coverage |
| Study | 1072 | 82.46% | 10.26% | 7.28% | 81% | 83% |
| 1 | | | | | | |
| Study | 123 | 91.06% | 8.13% | 0.81% | 83% | 93% |
| 2 | | | | | | |
| Study | 110 | 77.27% | 16.36% | 6.37% | 80% | 83% |
| 3 | | | | | | |
| Study | 17 | 41.18% | 11.76% | 47.06% | 56% | 90% |
| 4 | | | | | | |

In some implementations, process 200 can execute refined master and sub-problems. For example, the refined master problem and refined sub-problem (defined below) take into account additional reserve pattern parameters. The refined master problem and refined sub-problem allow for reserve coverage of trips that extend across two duty months (e.g., a scheduled airline trip that begins at the end of one duty month but is not completed until the beginning of the following duty month).

### Refined Master Problem:

$$\begin{matrix}Min {\sum }_{j ∈ J} {c}_{j} {x}_{j} + {\sum }_{d ∈ D} {s}_{d} {u}_{d} & ( 2.1 ) \\ Subject To \text{:} & \\ {\sum }_{j ∈ J} {p}_{j}^{d} {x}_{j} + {u}_{d} \geq {n}_{d} ∀ d & ( 2.2 ) \\ {\sum }_{j ∈ J} {x}_{j} = U & ( 2.3 ) \\ {\sum }_{j ∈ J} {δ}_{j} {x}_{j} \leq β {\sum }_{j ∈ J} {x}_{j} & ( 2.4 ) \\ {x}_{j} ∈ \{ 0 , 1 \} ; {u}_{d} \geq 0 & ( 2.5 )\end{matrix}$$

The master problem (2.1-2.5) is a set cover problem and it is always feasible because of the existence of u_{d}. Constraint sets (2.2) and (2.5) are the same as constraint sets (1.2) and (2.5) above. Constraint set (2.2) describes how the subset of coverage covers the reserve demand. Constraint set (2.3) defines a maximum number of reserve pattern lines (U) (e.g., reserve pattern lines 1-20 in FIG. 7). For example, if a stuffing analysis predicts that only 25 reserve crew will be available next bid month, constraint (2.3) limits the total number of reserve patterns to 25 reserve lines (e.g., one line per each available reserve crew).

Constraint set (2.4) allows for an additional “special” reserve pattern parameter. Specifically, constraint set (2.4) is a check to confirm that the total number of “special” reserve duty patterns are limited to a particular percentage of the total duty patterns. Special reserve duty patterns can include, but are not limited to, patterns with a unique number of on-duty days that are fewer than a standard minimum or more than a standard maximum number of on-duty days; or patterns that avoid weekend on-duty days. For instance, an airline may permit a limited number of short duty periods (e.g., duty patterns containing fewer than a standard minimum number of on-duty days) per duty month. In constraint set (2.4) δⱼ is binary value indicating whether reserve pattern j is a “special” reserve duty pattern; δⱼ is set to 1 if pattern j is a “special” pattern (e.g., having fewer than the standard minimum number of on-duty days) and is 0 otherwise. β represents the airline's desired limit on the number of “special” duty patterns per bid period; e.g., β represents a maximum percentage of the total reserve duty patterns (e.g., between 0 and 50%).

Similar to master problem (1.1-1.3), in order to make the problem tractable, columns (associated with xⱼ) are iteratively created, following the column generation procedure. When its linear relaxation (e.g., xⱼ∈[0,1]) is solved to its optimality, the shadow value (e.g., shadow price) of constraint d (open-time trip demand and denoted by w_{d}) can be determined.

For each possible reserve pattern, process 200 uses the sub-problem (defined below) to calculate a potential improvement value (vₘ+w_{|D|+1}+(δᵢ−0.1)w_{|D|+2}−c) of the pattern, where w_{IDI+1} represents the shadow value associated with constraint (2.3) and (δᵢ−0.1)w_{|D|+2} represents a shadow value associated with constraint (2.4). The improvement value represents the potential cost improvement that a given pattern will provide to the overall optimization model as governed by the master set cover problem. In order to reduce the solving time, the set of all possible reserve duty patterns, I, is generated in the sub-problem. Variable rₜ^{f} is used to locate all the on duty days in the bid period. rₜ^{f} is 1, if day t is the fth on duty day in this pattern, and is 0 otherwise.

### Refined Sub-Problem:

$$\begin{matrix}\begin{matrix}{v}_{m} = max {\sum }_{d ∈ D} {w}_{d} {q}_{d} - \\ {\sum }_{t = T + 1 , … , {T}^{′}} ( c / 15 ) {O}_{i}^{r}\end{matrix} & & ( 2.6 ) \\ Subject To \text{:} & & \\ {O}_{i}^{t} \geq {O}_{i}^{t + 1} & ∀ t = T , … , {T}^{′} - 1 & ( 2.10 ) \\ {\sum }_{d = 1}^{D} {h}_{d}^{t} {q}_{d} \leq {O}_{i}^{t} & ∀ t = 1 , … , {T}^{′} & ( 2.7 ) \\ {q}_{d} \leq {n}_{d} & ∀ d & ( 2.8 ) \\ {\sum }_{t = 1}^{T} {O}_{i}^{t} = P & & ( 2.9 ) \\ {\sum }_{t ∈ ℒ} {O}_{i}^{t} = 0 & & ( 2.12 ) \\ {\sum }_{k = 1}^{K + 1} {y}_{k} = T - P & & ( 2.11 ) \\ 0 \leq {q}_{d} \leq 1 , {r}_{t}^{f} , {O}_{i}^{t} ∈ \{ 0 , 1 \} , & {y}_{k} \geq 0 integer & ( 2.13 ) \\ {\sum }_{t = 1}^{T} {r}_{t}^{f} = 1 & ∀ f & ( 2.14 ) \\ {O}_{i}^{t} = {\sum }_{f = 1}^{P} {r}_{t}^{f} & ∀ t & ( 2.15 ) \\ {\sum }_{t = 1}^{T} {r}_{t}^{f} t = {y}_{1} + 1 & ∀ f = ( 1 , 2 , … , {a}_{1} ) & ( 2.16 .1 ) \\ {\sum }_{t = 1}^{T} {r}_{t}^{f} t = {y}_{1} + {a}_{1} + {y}_{2} + 1 & \begin{matrix}∀ f = ( {a}_{1} + 1 , {a}_{1} + \\ 2 , … , {a}_{1} + {a}_{2} )\end{matrix} & ( 2.16 .2 ) \\ \begin{matrix}{\sum }_{t = 1}^{T} {r}_{t}^{f} t = {y}_{1} + {a}_{1} + \\ {y}_{2} + {a}_{2} + {y}_{3} + 1\end{matrix} & \begin{matrix}∀ f = ( {a}_{1} + {a}_{2} + \\ 1 , {a}_{1} + {a}_{2} + \\ 2 , … , {a}_{1} + {a}_{2} + {a}_{3} )\end{matrix} & ( 2.16 .3 ) \\ ⋮ & ⋮ & ⋮ \\ {\sum }_{t = 1}^{T} {r}_{t}^{f} t = {\sum }_{k = 1}^{K} {y}_{k} + {\sum }_{k = 1}^{K - 1} {a}_{k} + 1 & \begin{matrix}∀ f = ( {1}_{1} + {a}_{2} + … + \\ {a}_{K - 1} + 1 , {a}_{1} + {a}_{2} + … + \\ {a}_{K - 1} + 2 , … {a}_{1} + {a}_{2} + … + {a}_{K} )\end{matrix} & ( 2.16 . K )\end{matrix}$$

The stop condition for the refined sub-problem is also modified. After solving the sub-problem, if vₘ+w_{|D|+1}+(δᵢ−0.1)w_{|D|+2}>c, the system adds a column q_{d} into the coverage rate matrix, J, with the cost coefficient of c+Σ_{t=T+1, . . . , T′}(c/15)Oᵢ^{t} in the objective function. The system will assign pⱼ^{d}=q_{d} for the new column. Otherwise, the system stops the sub-problem and solves the master problem (2.1-2.5) with full integer constraints (e.g., xⱼ∈{0,1}).

As in the previously described sub-problem, in the refined sub-problem the largest vₘ is selected to create a new column in the master problem with the coefficient vector of q_{d}. m denotes the element of set M which includes all legal on-duty blocks types (e.g., all on-duty block types that meet the minimum number of on-duty days per duty block (MB). In the refined sub-problem constraint set (2.6), the calculation of vₘ, has been modified from constraint set (1.4) above, and constraint sets (2.10) and (2.12) have been added to the refined sub-problem. The remaining constraint sets in the refined sub-problem are unchanged.

The calculation of vₘ, constraint (2.6), has been modified to account for carry-over reserve patterns. Carry-over reserve patterns are reserve patterns that overlap two bid months. For instance, a carry-over reserve pattern begins at the end of a first bid month and ends in the beginning of a subsequent bid month. The additional cost term Σ_{t=T+1, . . . , T′}(c/15)Oᵢ^{t} in (2.6) for duty pattern days that extend into a subsequent bid month is deducted from the calculation of vₘ, where T is the total number of days in the current bid month and T′ is the total number of days in the subsequent bid month.

Constraint set (2.10) checks for carry-over trips by comparing on-duty days in each duty pattern Oᵢ to determine if the pattern includes any on-duty periods that extend from one bid month (T) into the next bid month (T′). On-duty days are represented by a 1 and off-duty days are represented by a 0. If a duty pattern Oᵢ carries over to the next bid month the inequality will be true.

Constraint set (2.12) is employed to check “special” reserve patterns for weekend duty. [symbol] represents the set of weekend days in a bid month. If a duty pattern does not include any “special” reserve patterns, [symbol] is set to Ø (null set). Constraint set (2.12) prevents “special” reserve patterns from including weekend duty days by setting a disallowed duty pattern Oᵢ to zero.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer, storage medium is not a propagated signal; a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, for example, a CRT (cathode ray tube) or LCD (liquid crystal display) monitor, for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component (e.g., such as a data server), or that includes a middleware component (e.g., an application server), or that includes a front-end component (e.g., a client computer having a graphical user interface or a Web browser through which a user can interact with an implementation of the subject matter described in this specification), or any combination of one or more such back-end, middleware, or front-end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An airline reserve scheduling system comprising:
one or more processors;
one or more tangible, non-transitory media operably connectable to the one or more processors and storing instructions that, when executed, perform operations comprising:
obtaining input data comprising forecasting data and reserve duty pattern parameters;
iteratively generating additional coverage rate columns for a reserve-demand coverage rate (RDCR) matrix until a stop criterion is satisfied, each iteration comprising:
determining, for a set of coverage rate columns within the RDCR matrix, a shadow value indicating a marginal value of an incremental change in reserve-demand coverage of a plurality of airline trips, the set of coverage rate columns selected for the iteration;
determining, based on the input data, a plurality of possible reserve duty patterns to cover the plurality of airline trips;
determining an improvement value for each of the possible reserve duty patterns, where each improvement value is determined based on the shadow value and a trial coverage rate associated with each possible reserve duty pattern;
identifying a particular reserve duty pattern from among the possible reserve duty patterns with a respective improvement value that is a highest among all the improvement values of the possible reserve duty patterns;
determining whether the respective improvement value satisfies the stop criterion; and
if the improvement value of the particular reserve duty pattern does not satisfies the stop criterion:
generating a new coverage rate column from the trial coverage rate associated with the particular reserve duty pattern, and
appending the new coverage rate column to RDCR matrix as an additional coverage rate column;
if the improvement value of the particular reserve duty pattern does satisfy the stop criterion, ceasing the iteratively generating additional coverage rate columns; and
generating, based on the RDCR matrix, a final set of reserve duty patterns.

2. The system of claim 1, wherein the additional coverage rate columns for the RDCR matrix are generated using linear problem constraints.

3. The system of claim 1, wherein the final set of reserve duty patterns are generated using integer problem constraints.

4. The system of claim 1, wherein the additional coverage rate columns for the RDCR matrix are generated as using linear problem constraints, and wherein the final set of reserve duty patterns are generated using integer problem constraints.

5. The system of claim 1, wherein the forecasting data associates a plurality of airline trips with an expected reserve-demand value that indicates a probability that each airline trip will require coverage by a reserve crew.

6. The system of claim 5, wherein the forecasting data includes at least some expected reserve-demand values associated with multi-day airline trips.

7. The system of claim 5, wherein the forecasting data includes expected reserve-demand value that are not rounded.

8. The system of claim 1, wherein the reserve duty pattern parameters include a reserve pattern length and a minimum number of on duty days per reserve block.

9. The system of claim 1, wherein determining the shadow value comprises solving a set cover problem based on the set of coverage rate columns within the RDCR matrix and using linear problem constraints.

10. The system of claim 9, wherein generating the final set of reserve duty patterns comprises solving the set cover problem based on a final set of columns of the RDCR matrix and using integer problem constraints.

11. The system of claim 1, wherein the operations further comprise generating a revised set of reserve duty patterns by solving a set cover problem based on the RDCR matrix and hybrid forecasting data, wherein the hybrid forecasting data associates a first plurality of airline trips with an actual reserve demand data and a second plurality of airline trips an expected reserve-demand value that indicates a probability that each airline trip will require coverage by a reserve crew.

12. The system of claim 1, wherein the reserve duty pattern parameters include a limited number of special reserve duty patterns.

13. A computer implemented method comprising:
obtaining input data comprising forecasting data and reserve duty pattern parameters;
iteratively generating additional coverage rate columns for a reserve-demand coverage rate (RDCR) matrix until a stop criterion is satisfied, each iteration comprising:
determining, for a set of coverage rate columns within the RDCR matrix, a shadow value indicating a marginal value of an incremental change in reserve-demand coverage of a plurality of airline trips, the set of coverage rate columns selected for the iteration;
determining, based on the input data, a plurality of possible reserve duty patterns to cover the plurality of airline trips;
determining an improvement value for each of the possible reserve duty patterns, where each improvement value is determined based on the shadow value and a trial coverage rate associated with each possible reserve duty pattern;
identifying a particular reserve duty pattern from among the possible reserve duty patterns with a respective improvement value that is a highest among all the improvement values of the possible reserve duty patterns;
determining whether the respective improvement value satisfies the stop criterion; and
if the improvement value of the particular reserve duty pattern does not satisfies the stop criterion:
generating a new coverage rate column from the trial coverage rate associated with the particular reserve duty pattern, and
appending the new coverage rate column to the RDCR matrix as an additional coverage rate column;
if the improvement value of the particular reserve duty pattern does satisfy the stop criterion, ceasing the iteratively generating additional coverage rate columns; and
generating, based on the RDCR matrix, a final set of reserve duty patterns.

14. The method of claim 13, wherein the additional coverage rate columns for the RDCR matrix are generated using linear problem constraints.

15. The method of claim 13, wherein the final set of reserve duty patterns are generated using integer problem constraints.

16. The method of claim 13, wherein the forecasting data associates a plurality of airline trips with an expected reserve-demand value that indicates a probability that each airline trip will require coverage by a reserve crew,
wherein the forecasting data includes at least some expected reserve-demand values associated with multi-day airline trips, and
wherein the forecasting data includes expected reserve-demand value that are not rounded.

17. The method of claim 13, wherein determining the shadow value comprises solving a set cover problem based on the set of coverage rate columns within the RDCR matrix and using linear problem constraints, and
wherein generating the final set of reserve duty patterns comprises solving the set cover problem based on a final set of columns of the RDCR matrix and using integer problem constraints.

18. The method of claim 13, further comprising generating a revised set of reserve duty patterns by solving a set cover problem based on the RDCR matrix and hybrid forecasting data, wherein the hybrid forecasting data associates a first plurality of airline trips with an actual reserve demand data and a second plurality of airline trips an expected reserve-demand value that indicates a probability that each airline trip will require coverage by a reserve crew.

19. A computer implemented method comprising:
obtaining input data comprising forecasting data and reserve duty pattern parameters;
iteratively generating additional coverage rate columns for a reserve-demand coverage rate (RDCR) matrix until a stop criterion is satisfied, each iteration comprising:
determining a shadow value indicating a marginal value of an incremental change in reserve-demand coverage of a plurality of airline trips by solving a set cover problem based on a set of coverage rate columns within the RDCR matrix and using linear problem constraints, the set of coverage rate columns selected for the iteration;
generating a new reserve duty pattern, the new reserve duty pattern comprising an improvement value;
determining whether the improvement value of the new reserve duty pattern satisfies the stop criterion; and
if the improvement value of the new reserve duty pattern does not satisfies the stop criterion:
generating a new coverage rate column based on the new reserve duty pattern, and
appending the new coverage rate column to the RDCR matrix as an additional coverage rate column;
if the improvement value of the new reserve duty pattern does satisfy the stop criterion, ceasing the iteratively generating additional coverage rate columns; and
generating, based on the RDCR matrix, a final set of reserve duty patterns.

20. The method of claim 19 wherein generating a new reserve duty pattern comprises:
determining, based on the input data, a plurality of possible reserve duty patterns to cover the plurality of airline trips;
determining an improvement value for each of the possible reserve duty patterns, where each improvement value is determined based on the shadow value and a trial coverage rate associated with each possible reserve duty pattern; and
selecting a particular reserve duty pattern from among the possible reserve duty patterns based on the particular reserve duty pattern having a respective improvement value that is a highest among all the improvement values of the possible reserve duty patterns.
